(19) United States
(12) Patent Application Publication
(10) Pub. No.: US 2005/0083300 A1
(43) Pub. Date: Apr. 21, 2005

(54) Pointer control system

(76) Inventor: Daniel C. Castle, Manmouth, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/690,036

(22) Filed: Oct. 20, 2003

(51) Int. Cl. G09G 5/08; G09G 5/00; G10L 15/00; G10L 21/00; G10L 21/06

(52) U.S. Cl. 345/157; 345/158; 345/160; 345/168; 345/171; 345/173; 345/184; 345/156; 704/275; 704/276; 704/251

(57) ABSTRACT

Systems for controlling the motion of a pointer on a display. These systems may involve, among other aspects, (1) providing a reference object on the display; (2) defining an orientation indicated by the reference object; (3) changing the orientation indicated by the reference object; (4) moving the pointer in response to a start movement signal, in a direction correlated with the orientation indicated by the reference object.

### BACKGROUND

Modern electronic systems often utilize a Graphical User Interface (GUI), in which executable programs, file storage locations, documents, and the like may be represented on a display as graphical objects. A user may select or activate one of these programs, locations, documents, or the like using a controllable pointer on the display. This selection or activation may be accomplished by first moving the pointer near a particular graphical object on the display, and then performing one or more pointer functions. Examples of pointer functions include executing programs, opening documents, deleting files, and resizing, moving, opening, or closing windows and/or icons on a display, among others.

Commonly, a pointer is controlled using a computer “mouse.” A computer mouse may include, for example, a mechanical and/or optical detection system for detecting motions of the mouse relative to a substantially flat surface, such as a mouse pad. Detected motions may be converted into electrical signals that typically are conveyed to a processor, which uses the signals to control the motions of the pointer. Similarly, pointer functions other than movement may be controlled using various buttons, wheels, and the like that are associated with the computer mouse. For example, through motions of a computer mouse on a mouse pad or other substantially flat surface, a pointer on a display may be moved into close proximity with an icon representing an executable program. With the pointer in close proximity to the icon, double-clicking a button associated with the computer mouse may cause the program to be executed by the processor, in a manner familiar to users of personal computers.

A pointer also may be controlled, in similar fashion, using alternative pointing devices, such as a dedicated track ball, light pen, a joystick, or touch pad, among others. Each of these devices may be configured such that human motions may be detected, converted to electrical signals, and transmitted to a processor to control motions and functions of a pointer on a display.

A pointer also may be controlled using a keyboard, either alone or in conjunction with a pointing device such as those identified above. However, this approach generally is more cumbersome than using a pointing device alone, and thus may be more rarely used in practice.

Situations may arise in which controlling a pointer on a display with a pointing device and/or keyboard is undesirable. For example, a physically disabled person may not be able to manipulate a pointing device or keyboard effectively. In other cases, a user may wish to control motions and functions of a pointer on a display without being in direct physical contact with a pointing device or keyboard. In some instances, it may be desirable to allow control of a pointer on a display by several users simultaneously. In each of these cases, it may be difficult or impossible to control the pointer with a conventional pointing device and/or keyboard.

To overcome these difficulties, methods have been developed to control a pointer on a display by voice. These methods typically involve voice-recognition software that attempts to recognize a set of spoken signal words correlated with desired pointer motions and functions. Recognized signals then may be converted into electrical signals to control the pointer. However, existing voice control methods typically require a voice recognition program to be “trained” to the sound of each user's voice, and often require a relatively large signal set to control a pointer. Furthermore, fine control over the motions of a pointer may be difficult to achieve by voice. In particular, it may require a large number of iterated voice recognition events before the pointer arrives at a desired position on a display and performs the desired functions.

### BRIEF DESCRIPTION OF THE DRAWINGS

FIG. 1 shows a diagram of a display connected to a processor, including a pointer and a reference object.

FIG. 2 shows a diagram of a display connected to a processor, including a pointer that functions as its own reference object.

FIG. 3 shows a diagram of a display connected to a processor, including a pointer and another embodiment of a reference object.

FIG. 4 shows a diagram including a primary display with a pointer, and a secondary display with a reference object.

### DETAILED DESCRIPTION

Systems are provided for controlling the motion of a pointer on a display. These systems may involve, among other aspects, correlating movement of the pointer with an orientation indicated by a graphical reference object. The reference object generally may be any graphical object capable of directly or indirectly indicating an orientation or direction. For example, a directed arrow may conveniently function as the reference object. The orientation indicated by the reference object may be changeable relative to the display and/or the pointer, and movement of the pointer may be correlated with this orientation, as described below.

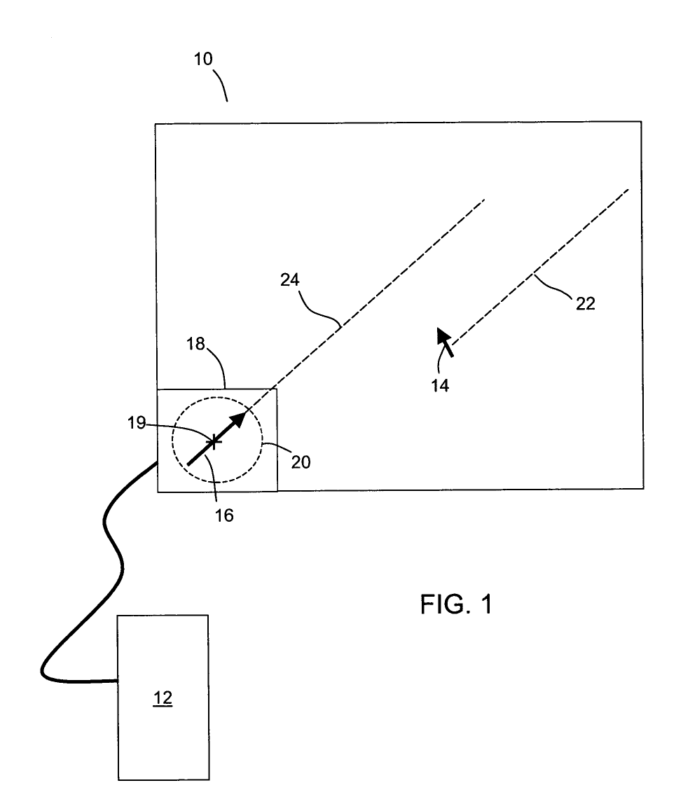

FIG. 1 shows a diagram of a display 10 connected to a processor 12. The display generally comprises any mechanism or device for providing information in a visual form, such as a computer monitor, a projector, a screen, and so on. The display may include a pointer 14 and a reference object 16. The processor generally comprises any mechanism or device such as logic circuitry for receiving, interpreting, executing, and/or outputting instructions. The processor may include a computer chip, and may be associated with a computer, personal digital assistant, media player (e.g., tape, optical disk, etc.), radio, television, positioning system (e.g., global positioning system (GPS), etc.), and/or communication device (e.g., telephone, etc.), among others.

Pointer 14 generally includes any graphical object, recognizable on a display, that is capable of directly or indirectly denoting absolute and/or relative position (and/or, in some cases, orientation). For example, a pointer may be represented as an arrow, an hourglass, a finger, a crosshair, and/or an animal, among others. The exact representation of the pointer generally will have little or no bearing on its functionality. In FIG. 1, pointer 14 is a non-rotating arrow whose movement is under operator control.

Reference object 16 generally includes any graphical object, recognizable on a display, that is capable of directly or indirectly denoting an orientation. Unlike a pointer, the reference object typically will not be used for selecting and/or activating files. The reference object generally may have any suitable size and/or shape. For example, as shown in FIG. 1, the reference object may be represented as a graphical arrow, optionally residing in a dedicated (e.g., corner) portion 18 of display 10. Additional representations for reference objects are described below.

The reference object may be an aid for moving the pointer, in a desired direction and/or to a desired location. For example, in FIG. 1, reference object 16 is rotatable, and may be used for specifying a direction of movement (e.g., translation) for pointer 14. Specifically, in this example, the reference object is configured to rotate around an axis 19 whenever the pointer is stationary (dashed circle 20 indicates the rotational path traced out by the head of the reference object). To move pointer 14 in a desired direction, indicated by dashed line 22, an operator may transmit a start movement signal to processor 12 when the reference object points in a direction parallel to (or at least generally corresponding to or correlated with) the desired direction of movement, as indicated by dashed line 24. The start movement signal causes the pointer to begin moving in the desired direction. When the pointer reaches a desired location on the display, the operator may transmit a stop signal to the processor, causing the pointer to stop moving. The start movement signal and the stop movement signal also may cause the reference object to stop reorienting (e.g., rotating or revolving) and/or to resume reorienting (e.g., rotating or revolving), respectively, thus “freezing” the orientation of the reference object while the pointer is moving.

The dashed lines in FIG. 1 (22, 24) and subsequent figures show extrapolated directions or orientations. These lines and/or any other suitable indicator of direction and/or trajectory may, independently, be shown or not shown on the display. Suitable indicators may include dashed, solid, and/or dotted lines, among others. Suitable trajectories may include straight and/or curvilinear, and continuous and/or discontinuous, among others.

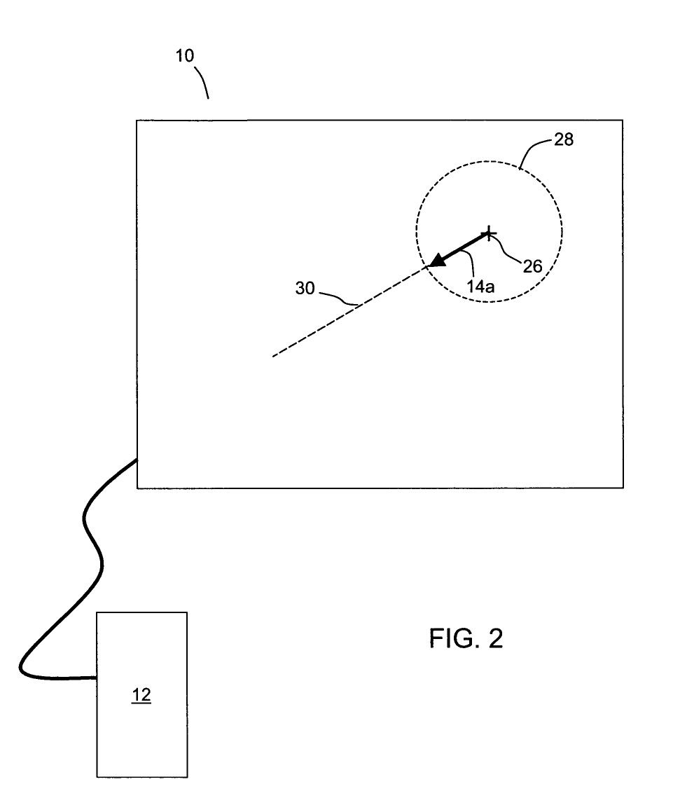

In other embodiments, a rotatable pointer may function as a reference object for specifying its own direction of translation. In other words, the pointer and the reference object may be identical in such embodiments. For example, FIG. 2 depicts display 10 connected to processor 12, with a pointer 14a represented by a rotating arrow on the display. Pointer 14a may be configured to rotate around an axis 26 that translates along with the pointer. The path traced out by the head of the pointer is indicated by dashed circle 28. Although axis 26 is shown through the tail of pointer 14a, the pointer equivalently may rotate about any axis on the display. When the rotating arrow points in a desired direction of translation for the pointer, an operator-inputted start movement signal transmitted to processor 12 may cause the pointer to stop rotating and to begin moving in that direction, as indicated by dashed line 30 in FIG. 2. When the pointer reaches a desired location on the display, an operator-inputted stop movement signal may cause the pointer to stop moving, and to resume rotating.

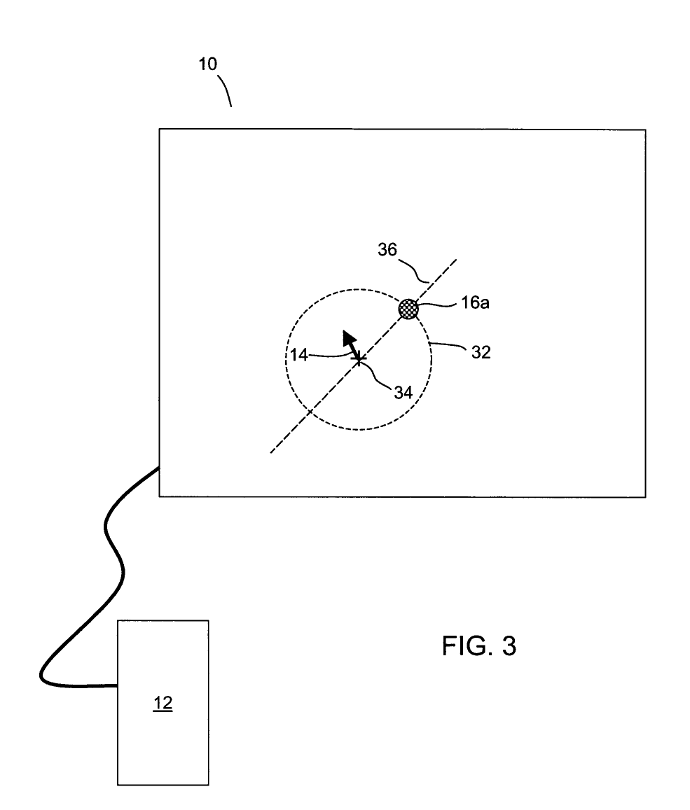

In still other embodiments, a reference object may take the form of a graphical figure that changes its orientation with respect to a pointer, while maintaining an approximately constant distance from it. For example, FIG. 3 depicts a reference object 16a in the form of an icon configured to undergo circular revolution, indicated by dashed circle 32, centered around an axis 34 through the tail of pointer 14. (The reference object equivalently may revolve around an axis through any portion of the pointer.) When an operator-inputted start movement signal is received at processor 12, reference object 16a may stop revolving and begin to move (e.g., translate) in a direction towards pointer 14, “pushing” the pointer in front of it, while maintaining an approximately constant distance from the pointer. (Alternatively, or in addition, the reference object may move away from the pointer, “pulling” the pointer behind it, or the reference object may move alongside the point, “walking” the pointer.) The pointer and the reference object thus would move along a direction indicated by dashed line 36. When pointer 14 arrives at a desired location on the display, an operator-inputted stop movement signal may cause the pointer and reference object to stop moving, and the reference object may resume revolving around the pointer.

In still other embodiments, a reference object may take the form of a text box or other indicator that indicates orientation symbolically. For example, the text box may include words, numbers, and/or other symbols that indirectly indicate direction, such as (1) up, down, left, right, (2) north, south, east, west, (3) 90, 270, 0, 180 degrees, etc., and/or any direction in-between.

Properties of a pointer may be adjustable. Specifically, the speed at which the pointer moves and/or the route along which the pointer travels in response to a start movement signal may be adjustable to accommodate displays of various sizes, operators with various experience levels, and/or other relevant factors. For example, the pointer translating speed may have a default value of approximately 100 pixels per second, and may be adjustable in a range between about 10 pixels per second and about 1000 pixels per second, among others. In embodiments with a rotatable pointer (see FIG. 2), the rotation direction and/or speed of the pointer also may be adjustable. For example, the pointer rotation speed may have a default value of approximately 0.5 Hertz (Hz), and may be adjustable in a range between about 0.1 Hz and about 2 Hz, among others. The pointer rotation direction may be chosen to be clockwise or counterclockwise. Additional properties of the pointer, such as its size, shape, and color, among others, also may be adjustable.

Properties of a reference object similarly may be adjustable. For instance, the reference object may be selectively configured to appear and disappear from the display, automatically or in response to operator signals received by an associated processor. In embodiments in which the reference object rotates or revolves around the pointer (see, e.g., FIG. 3), the separation between the reference object and the pointer may be adjustable. For example, the separation may have a default value of approximately 50 pixels, among others, and may be adjustable in a range from approximately 10 pixels to approximately 200 pixels, among others. The speed and/or direction (of revolution or rotation, depending on the embodiment) of the reference object also may be adjustable. For example, the reference object rotation or revolution speed may have a default value of approximately 0.5 Hz, among others, and may be adjustable in a range from approximately 0.1 Hz to approximately 2 Hz, among others. The reference object rotation or revolution direction may be chosen to be clockwise or counterclockwise. Moreover, the rotation or revolution may occur at constant or variable speed, along a circular, elliptical, and/or otherwise-shaped path.

Additional properties of the reference object, such as its size, shape, color, and/or any other aspects of its appearance and functionality, also may be adjustable. The reference object may include any contiguous graphical indicium, such as a directed arrow, that includes an asymmetry of shape and/or color that allows a direction to be correlated with each orientation of the reference object. Alternatively or in addition, the reference object may include a set of discrete (i.e., non-contiguous) graphical points, where at least one of the points is distinguishable from the others, again so that a direction may be associated with each orientation of the reference object. Alternatively, or in addition, the reference object may include a text box, as described above, for symbolically representing orientation.

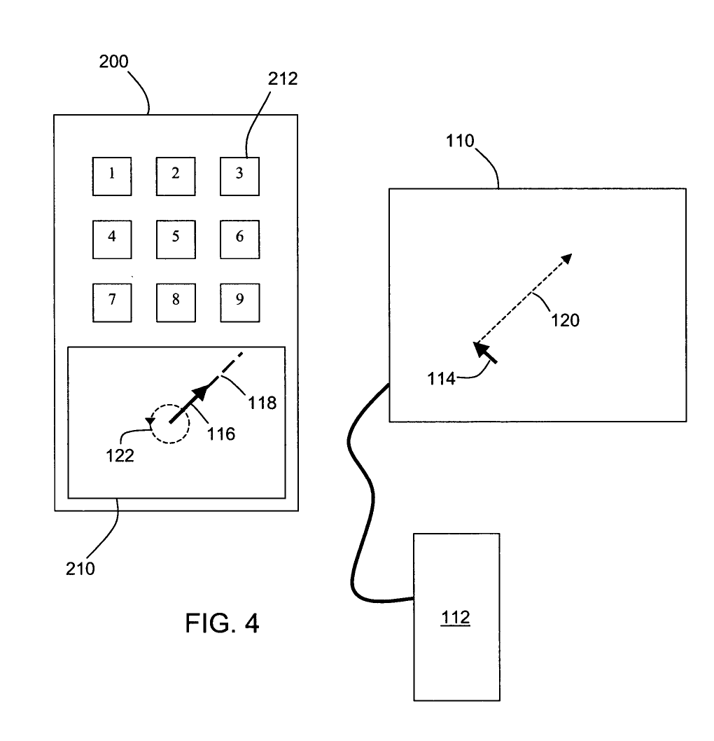

The reference object may be provided on a secondary display, in some embodiments, in addition to or instead of on the same display as the pointer. This reference object generally may include any of the properties and may take any of the forms possible for reference objects that appear on the same display as the pointer. FIG. 4 shows a primary display 110 connected to a processor 112, with a pointer 114 visible on the primary display. FIG. 4 also shows a remote control unit 200, including a secondary display 210 and a keypad 212, with a reference object 116 in the shape of an arrow visible on the secondary display. Each orientation of the reference object on the secondary display corresponds to a possible direction of movement of the pointer on the primary display. For example, when the reference object points up and to the right on the secondary display, as indicated by dashed line 118, this orientation corresponds to a direction of movement of the pointer that is up and to the right on the primary display, as indicated by dashed line 120. Here, the reference object rotates on the secondary display, as indicated by dashed circle 122, until it points in a direction corresponding to a desired direction of movement of the pointer. At that time, an operator start movement signal may be sent from remote control 200 to processor 112, for example, using keypad 212. The start movement signal causes the pointer to move in the desired direction until it arrives at a desired location, at which point an operator stop movement signal causes the pointer to stop moving. The operator signals may be communicated from remote control 200 to processor 112 by wires, by electromagnetic waves, and/or by any other suitable mechanism. This communication may include embodying the data signal in a carrier wave comprising instructions executable by a computer for controlling a pointer on a primary display with a secondary display. As in other embodiments, the reference object may be configured to change (e.g., rotate) continuously, it may be configured to change at all times except during movement of the pointer, or it may be configured to start and stop changing in response to separate operator signals.

In the embodiments described so far, an operator start movement signal causes the pointer to begin moving, and an operator stop movement signal causes the pointer to stop moving. The exact method of transmitting these signals is not important, since the operator signals do not carry information about the direction of movement of the pointer. Rather, the pointer's direction of movement is determined by the orientation indicated by the reference object (which may be identical to, or integrated with, the pointer) when the start movement signal is received.

Start and stop movement signals may be provided by any suitable mechanism, including, among others, a keystroke received at a keyboard, a click received at a mouse button, a touch received at a touch pad, and/or a sound received at a microphone. Complete control over translation of the pointer therefore may be obtained with a command set that minimally includes only one form of user input, which may be used both to start and to stop translation of the pointer. Operator signals that include one or more sounds received at a microphone may incorporate well-known sound and/or voice recognition techniques.

It may be desirable for the operator to send additional signals, other than start and stop movement signals, to control the pointer and/or reference object. For instance, it may be desirable to send signals that cause the reference object to appear, disappear, begin revolving or rotating, reverse direction of revolution or rotation, stop revolving or rotating, and/or change appearance and/or functionality in other ways. Thus, an operator may send an “appear signal” that causes the reference object to appear on the display, followed by a “revolution signal” that causes the reference object to revolve around the pointer, a “movement signal” that causes the pointer to begin translating, a “stop signal” that causes the pointer to stop translating, and a “disappear signal” that causes the reference object to disappear from the display. Each of the signals may be separate and independent, or two or more of the signals (such as the “appear” and “revolution” signals) may be combined as a single signal. It also may be desirable for the operator to send various “function signals” that cause the pointer to perform one or more functions, such as the pointer functions described previously. These additional signals, like the movement and stop signals, generally may be provided by any suitable mechanism.

The systems described herein may be used to move a pointer to a new position in a single start/stop operation and/or through a series of start/stop operations. For example, it may be desirable or necessary to use a series of operations if a first operation failed to bring the cursor to a desired location, because the operator “misaimed” or “undershot” or “overshot,” and/or because the available orientations did not allow direct movement between the initial start and final stop locations, among other reasons.

The instructions for using or controlling a pointer, reference object, and/or other features or processes described herein may be provided in any suitable format, including software, firmware, and/or hardware, among others. For example, in some embodiments, the instructions may be stored on and directly and/or indirectly readable from a storage medium, such as a magnetic medium (e.g., floppy disk, tape, etc.) and/or an optical medium (e.g., compact disk (CD), digital video disk (DVD), etc.), among others.

While the present description has been provided with reference to the foregoing embodiments, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring, nor excluding, two or more such elements.

1. A method of using a pointer on a display, comprising:
providing a reference object on the display;
defining an orientation indicated by the reference object;
changing the orientation indicated by the reference object; and
moving the pointer in response to a start movement signal, in a direction correlated with the orientation indicated by the reference object.

2. The method of claim 1, wherein moving the pointer in response to the start movement signal includes moving the pointer based on the orientation of the reference object at a time that the start movement signal is received.

3. The method of claim 1, wherein the start movement signal includes at least one sound received at a microphone.

4. The method of claim 1, wherein the start movement signal includes at least one keystroke received at a keyboard.

5. The method of claim 1, wherein the start movement signal includes at least one touch received at a touch pad.

6. The method of claim 1, further comprising stopping the pointer in response to a stop movement signal.

7. The method of claim 1, wherein the stop movement signal includes at least one sound received at a microphone.

8. The method of claim 1, wherein the stop movement signal includes at least one keystroke received at a keyboard.

9. The method of claim 1, wherein the stop movement signal includes at least one touch received at a touch pad.

10. The method of claim 1, further comprising performing at least one pointer function in response to at least one function signal.

11. The method of claim 10, wherein the at least one function signal includes a sound received at a microphone.

12. The method of claim 10, wherein the at least one function signal includes a keystroke received at a keyboard.

13. The method of claim 10, wherein the at least one function signal includes a touch received at a touch pad.

14. The method of claim 10, wherein changing the orientation indicated by the reference object includes revolving at least one point associated with the reference object around a point on the display.

15. The method of claim 14, wherein the revolving occurs in response to an operator signal.

16. The method of claim 15, wherein the revolving occurs in a direction of revolution determined by the operator signal.

17. The method of claim 14, wherein the revolving occurs unless the pointer is moving.

18. The method of claim 1, wherein the reference object is a contiguous graphical indicium.

19. The method of claim 18, wherein the reference object includes a graphical arrow.

20. The method of claim 18, wherein changing the orientation indicated by the reference object includes rotating the reference object.

21. The method of claim 20, wherein the rotating occurs unless the pointer is moving, and wherein the rotating does not occur while the pointer is moving.

22. The method of claim 21, further comprising performing at least one pointer function in response to at least one function signal.

23. The method of claim 21, further comprising removing the reference object from the display.

24. The method of claim 1, wherein the orientation indicated by the reference object changes automatically.

25. The method of claim 1, wherein the reference object includes a text box that includes an alphanumeric representation of the orientation.

26. A system for selecting points on a display, comprising:
an orientable reference object including at least one graphical point on a display that is selectively and automatically rotatable around another point on the display; and
a pointer configured to translate in response to a movement signal, in a direction correlated with an orientation of the reference object.

27. The system of claim 26, wherein the reference object includes a graphical arrow.

28. The system of claim 26, wherein the movement signal includes a keystroke received at a keyboard.

29. The system of claim 26, wherein the movement signal includes a touch received at a touch pad.

30. The system of claim 26, wherein the movement signal includes a sound received at a microphone.

31. The system of claim 30, wherein the sound is produced by a human voice.

32. The system of claim 26, wherein the pointer is further configured to perform at least one pointer function in response to an operator function signal.

33. The system of claim 26, wherein the pointer and the reference object are identical.

34. A system for controlling a pointer on a display, comprising:
means for providing a reference object indicating an orientation on the display;
means for changing the orientation indicated by the reference object;
means for moving the pointer in a direction correlated with the orientation indicated by the reference object in response to an operator-inputted start movement signal; and
means for stopping the pointer at a desired location on the display in response to an operator-inputted stop movement signal.

35. The system of claim 34, further comprising means for performing at least one pointer function in response to at least one operator-inputted function signal.

36. The system of claim 35, wherein the start movement signal, the stop movement signal, and the at least one function signal include at least one keystroke received at a keyboard.

37. The system of claim 35, wherein the start movement signal, the stop movement signal, and the at least one function signal include at least one touch received at a touch pad.

38. The system of claim 35, wherein the start movement signal, the stop movement signal, and the at least one function signal include at least one sound received at a microphone.

39. The system of claim 34, wherein means for changing the orientation of the reference object includes means for rotating the reference object.

40. The system of claim 39, wherein means for rotating the reference object includes means for rotating the reference object continuously unless the pointer is moving.

41. The system of claim 40, wherein means for rotating the reference object includes means for ceasing rotating the reference object while the pointer is moving.

42. The system of claim 39, further comprising:
means for adjusting rotating speed of the reference object;
means for adjusting size of the reference object; and
means for adjusting moving speed of the pointer.

43. The system of claim 42, further comprising means for removing the reference object from the display.

44. A storage medium readable by a computer, having embodied therein a program of executable instructions, comprising executable instructions for:
providing a pointer on a display;
providing a reference object on the display;
defining an orientation indicated by the reference object;
changing the orientation indicated by the reference object;
moving the pointer in a direction correlated with the orientation indicated by the reference object; and
stopping the pointer at a desired location on the display.

45. The storage medium of claim 44, wherein the executable instructions for moving the pointer are executed in response to an operator signal.

46. The storage medium of claim 45, wherein the executable instructions for moving the pointer effect movement of the pointer based on an orientation of the reference object at a time the operator signal is received.

47. The storage medium of claim 44, further embodying therein executable instructions for:
adjusting the rate at which the orientation of the reference object changes;
adjusting the size of the reference object; and
adjusting the speed at which the pointer moves.

48. The storage medium of claim 44, further embodying therein executable instructions for performing at least one pointer function.

49. The storage medium of claim 48, further embodying therein executable instructions for removing the reference object from the display.

50. A data signal embodied in a carrier wave, comprising:
instructions executable by a computer for controlling a pointer on a primary display with a secondary display, including instructions for:
providing a reference object on the secondary display;
defining an orientation indicated by the reference object;
changing the orientation indicated by the reference object;
moving the pointer on the primary display in a direction correlated with the orientation indicated by the reference object; and
stopping the pointer at a desired location on the primary display.

51. The data signal of claim 50, further including instructions for performing at least one pointer function.

52. The data signal of claim 50, wherein the reference object is a contiguous graphical indicium.

53. The data signal of claim 52, wherein the reference object is a graphical arrow.

54. The data signal of claim 50, further including instructions for removing the reference object from the secondary display.

55. The data signal of claim 50, further including instructions for removing the pointer from the primary display.

56. A computer having a graphical user interface, the graphical user interface comprising:
a display;
a reference object having an orientation on the display; and
a pointer on the display configured to selectively translate in a direction correlated with the orientation of the reference object.

57. The computer of claim 56, wherein the pointer translates in response to a keystroke received at a keyboard.

58. The computer of claim 56, wherein the pointer translates in response to a sound received at a microphone.

59. The computer of claim 58, wherein the sound is produced by a human voice.

60. The computer of claim 56, wherein the pointer translates in response to a touch received at a touch pad.

61. The computer of claim 57, wherein the orientation of the reference object changes in response to a keystroke received at a keyboard.

62. The computer of claim 58, wherein the orientation of the reference object changes in response to a sound received at a microphone.

63. The computer of claim 60, wherein the orientation of the reference object changes in response to a touch received at a touch pad.

64. The computer of claim 56, wherein the pointer is further configured to perform at least one pointer function in response to at least one operator function signal.
